(19) United States
(12) Patent Application Publication
(10) Pub. No.: US 2026/0051418 A1
(43) Pub. Date: Feb. 19, 2026

(54) Systems for Controlling a Beam of Charged Particles

(71) Applicant: Nusano, Inc., Valencia, CA (US)

(72) Inventors: Glenn B. ROSENTHAL, Los Angeles, CA (US); Finn H. O'Shea, Valencia, CA (US)

(21) Appl. No.: 18/813,409

(22) Filed: Aug. 23, 2024

Related U.S. Application Data
(60) Provisional application No. 63/684,584, filed on Aug. 19, 2024.

(51) Int. Cl. G21G 1/10; H05H 7/04; H05H 9/00

(52) U.S. Cl. CPC G21G 1/10; H05H 7/04; H05H 9/00; H05H 2007/048; H05H 2277/13

(57) ABSTRACT

Various embodiments include a charged particle beam management and control system for manipulating and controlling a beam of charged particles output from an accelerator to roughly match the size and shape of an irradiation target. Various embodiments achieve dynamic and flexible control of the beam shape at the target by using two octupole magnets in combination with a system of quadrupole magnets that shape the beam before entering each of the two octupole magnets. The magnetic fields of the quadrupole magnets are dynamically controlled by a computer processing system that receives information from beam sensors at or near the target to maintain beam shape and spread at the target. The system allows for the creation and maintenance of a uniform and square or rectangular beam profile at the target, suitable for applications such as isotope production and irradiation. The system is adaptable to different beam types, sizes, and shapes.

### CROSS REFERENCE TO RELATED APPLICATION

This application claims the benefit of priority to U.S. Provisional Application 63/684,584, filed Aug. 19, 2024, the entire contents of which are incorporated by reference for all purposes.

### BACKGROUND

Beam-induced transmutation is a mechanism of isotope production useful for transmuting elements into radioactive isotopes useful for various scientific, medical, and industrial applications. Charged particle beam management systems are critical components of systems that direct beams of charged particles onto a target to induce nuclear transmutations. In such systems, precise control over high-power charged particle beams (e.g., beams of leptons, protons, deuterium nuclei, tritium nuclei, alpha particles, partially ionized helium, or ionized heavier elements) is required to ensure production and efficiency objectives are met while minimizing undesired activation of system components. Such charged particle beam management systems may use charged particle beams with high intensity (e.g., 500 kW or greater) and a narrow width that will damage or destroy the target and portions of the system impacted by the beam if not properly managed. To mitigate such damage, beam manipulation techniques attempt to transform the initial beam profile into an expanded and more uniform beam profile that is compatible with the target size and material. Conventional systems suffer from limitations that restrict the ability to match beam profiles to target dimensions while achieving precision in beam alignment. Therefore, there is a need for advanced charged particle beam management systems that can independently control beam dimensions, simplify phase space preparation, and ensure uniform beam distribution, thereby improving the efficiency and safety of high-power charged particle beam applications.

### SUMMARY

Various aspects include methods and apparatuses for controlling a beam of charged particles. Some aspects include methods of controlling a beam of charged particles to produce a uniform beam shape at a target. Such methods may include passing a charged particle beam that is received from an accelerator and initial beam path elements through a first assembly of quadrupole magnets in which the orientation and magnetic field strength are configured to cause the beam to expand preferentially in a first direction and contract in a second direction perpendicular to the first direction, in which the first and second directions are perpendicular to the direction of travel of the beam, and passing the beam after exiting the first assembly of quadrupole magnets through a first octupole magnet that is configured to redirect particles towards a center portion of the beam. The methods may further include passing the beam after exiting the first octupole magnet through a second assembly of quadrupole magnets in which the orientation and magnetic field strength are configured to cause the beam to expand preferentially in the second direction and contract in the first direction passing the beam after exiting the second assembly of quadrupole magnets through a second octupole magnet that is configured to redirect particles towards the center portion of the beam, and allowing (and optionally manipulating) the beam to expand after exiting the second octupole magnet before striking a target.

Some aspects may further include passing the charged particle beam through one or more collimators along the path of the beam to remove particles outside of a desired beam distribution profile.

Some aspects may further include receiving information in a computing system from sensors positioned near the target regarding at least one of a uniformity, shape, size, or position of the beam at or near the target, and controlling by the computing system a magnetic field strength of one or more magnets within one or both of the first assembly of quadrupole magnets or second assembly of quadrupole magnets, and/or magnets within the first and second octupole magnets, in response to the received information regarding the uniformity, shape, size, or position of the beam at or near the target to maintain a predetermined threshold of the beam striking the target. In some aspects, receiving information in the computing system from sensors positioned near the target comprises receiving information from a beam-induced fluorescence monitor positioned near the target.

Some aspects may further include passing the beam through a third assembly of quadrupole magnets after exiting the second octupole magnet with magnetic strengths of the third assembly of quadrupole magnets adjusted by the control system to control a degree of expansion of the beam before striking the target.

Some aspects may further include passing the beam through an achromat bend comprising a plurality of quadrupole magnets having magnetic strengths controlled to focus the beam and compensate for chromatic dispersion in the charged particles received from the accelerator.

Further aspects may include system for directing a beam of charged particles (“charged particle beam” or “beam”) onto a target that includes a first assembly of quadrupole magnets positioned in the path of the beam, wherein the first assembly of quadrupole magnets are oriented and energized to produce magnetic fields configured to cause the beam to expand preferentially in a first direction and contract in a second direction perpendicular to the first direction, wherein the first and second directions are perpendicular to the direction of travel of the beam, a first octupole magnet positioned after the first assembly of quadrupole magnets along the path of the beam, wherein the first octupole magnet is configured to produce magnetic fields that redirect charged particles towards a center portion of the beam, a second assembly of quadrupole magnets position after the first octupole magnet along the path of the beam, wherein the second assembly of quadrupole magnets are oriented and energized to produce magnetic fields configured to cause the beam to expand preferentially in the second direction and contract in the first direction, a second octupole magnet positioned after the second assembly of quadrupole magnets along the path of the beam, wherein the second octupole magnet is configured to produce magnetic fields that redirect particles towards the center portion of the beam, and a beam expansion portion of the system configured to allow the beam to expand after exiting the second octupole magnet before striking the target.

Some aspects may further include one or more power units coupled to magnets within the first and second assemblies of quadrupole magnets and first and second octupole magnets, and configured to control power applied to the magnets in response to control signals, a beam-induced fluorescence monitor sensor positioned near the target and configured to provide information regarding at least one of a uniformity, shape, size, or position of the beam near the target, and a computing system electronically coupled the one or more power units and the sensor positioned near the target. In such aspects, the computing system may be configured to execute processor-executable instructions that cause the computing system to receive information from the sensor regarding at least one of a uniformity, shape, size, or position of the beam near the target, determine based on the information received from the sensor regarding at least one of a uniformity, shape, size, or position of the beam near the target changes to magnetic field strengths of magnets in one or more of the first and second assemblies of quadrupole magnets and/or the first and second octupole magnets to maintain the beam striking the target, and output control signals to the one or more power units based on the determined changes to magnetic field strengths.

Some aspects may further include a third assembly of quadrupole magnets positioned within the beam expansion portion, wherein magnetic strengths of magnets within the third assembly of quadrupole magnets are adjusted to control a degree of expansion of the beam before striking the target. Some aspects may further include an achromat bend including a plurality of quadrupole magnets configured to focus the beam and compensate for chromatic dispersion in the beam received from the accelerator. Some aspects may further include a target station comprising a mechanism for holding and loading targets into a target positioning device configured to hold a target in the path of the beam of charged particles.

Further aspects include methods performed by a computing system for controlling a charged particle beam within a charged particle beam management and control system, which includes controlling by the computing system one or more power units that power various magnets within the charged particle beam management and control system, receiving in the computing system beam quality information from a beam sensor at or near a target regarding at least one of beam size, shape, or position, determining by the computing system adjustments to magnetic field strengths or power applied to one or more system magnets to maintain beam quality based on the received beam quality information, and controlling by the computing system the one or more power units based on determined adjustments to magnetic field strengths or power applied to one or more system magnets. In some aspects, the computing system may determine adjustments to magnetic field strengths or power applied to one or more system magnets to maintain beam quality based on the received beam quality information using an optimization algorithm.

Further aspects include a computing device including a memory and a processing system having at least one processor configured to perform operations of any of the methods summarized above. Further aspects include a non-transitory processor-readable storage medium having stored thereon processor-executable software instructions configured to cause a processor to perform operations of any of the methods summarized above. Further aspects include a computing device having means for performing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example system for directing a beam of charged particles onto a target suitable for implementing various embodiments.

FIG. 2 is a component block diagram illustrating an example control system for a controlling a beam management and control system suitable for implementing various embodiments.

FIGS. 3A-3C are illustrations of magnet assemblies that may be used in systems for directing beams of charged particles onto a target.

FIGS. 4A-4B are graphs illustrating charged particle beam profiles output by a system for directing beams of charged particles onto targets according to various embodiments.

FIG. 5 is a process flow diagram illustrating an example method of directing a beam of charged particles onto a target according to some embodiments.

FIG. 6 is a process flow diagram illustrating an example control system method for controlling a beam of charged particles according to some embodiments.

FIG. 7 is a component block diagram illustrating an example general purpose computing system suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a charged particle beam management and control system for manipulating and controlling a beam of charged particles output from an accelerator to roughly match the size and shape of an irradiation target.

The descriptions of various embodiments refer to a first profile direction of the charged particle beam as the “X” direction and refer to a second beam profile direction perpendicular to the first direction as the “Y” direction. This is for ease of description, and it should be appreciated that the orientation of the two directions are arbitrary. In practice, the X and Y directions of the beam may be aligned with the width and height dimensions of a square or rectangular target. In some implementations, the target may be positioned in the system so the width dimension is parallel to the floor, and thus the X dimension may align with the floor and the Y dimension may align with the walls of a room in which the system is located. On the other hand, a square or rectangular target may be oriented within the system at any angle of rotation so that its width and height dimensions align with the X and Y dimensions of the beam produced by the system.

The term “charged particle” is used herein to refer to any particle carrying a charge that can be manipulated by magnetic fields, including leptons, protons, muons, deuterium nuclei, tritium nuclei, alpha particles, partially ionized helium, and ionized heavier elements.

The term “computing device” is used herein to refer generally to any of personal computers, desktop computers, laptop computers, all-in-one computers, workstations, supercomputers, mainframe computers, embedded computers (such as in control systems), computing systems within or configured for use in industrial systems, programmable logic controllers (PLC), field-programmable gate arrays (FPGA), and other devices that include a programmable processor or processing system of multiple processors.

Some embodiments are described in terms of code, e.g., processor-executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various embodiments.

The charged particle beam input to the beam management system of various embodiments may be a charged particle beam produced by an accelerator such as described in U.S. Pat. No. 8,624,502, which is incorporated herein by reference for its disclosure of beam formation technologies. The accelerator may generate a beam of charged particles that is smaller in profile than a target for collision-induced nuclear transmutation with a power density that could destroy the target and potentially any object in the path of the beam.

In order for a target to survive irradiation by a high-power beam, various embodiments include a system of magnet assemblies positioned along a beam path with the magnets configured as described herein to perform a non-linear transform of the beam to match the target dimensions. The beam path may be enclosed within an evacuated tube or beam pipe that passes through the various magnets in which a high vacuum is maintained to minimize scattering of charged particle particles off of air molecules.

The charged particle beam management and control system shapes and spreads the beam to approximately match the size and shape of the target with a relatively uniform beam intensity profile. Various embodiments provide a charged particle beam management and control system that enables the dimensions of the beam upon striking the targets to be chosen and controlled somewhat arbitrarily. In particular, the charged particle beam management and control system of various embodiments can produce at a target a beam of virtually any rectangular or square area within the range of likely target sizes. These qualities make the charged particle beam management and control system of various embodiments particularly suitable for producing radioactive isotopes through beam-induced transmutation.

A key to the beam shape and size manipulations performed by various embodiments is the use of two octupole magnets aligned in sequence along the beam path. Octupole magnets effectively fold the edges of a beam's distribution inwards. The resulting redirections of particles in the charged particle beam are like folding the edges of the distribution (e.g., the wings of a Gaussian distribution) over and adding those particles to the central part of the beam profile. The result is a more uniform profile of the beam exiting the magnet. This effect occurs because of the high order of the octupole magnet that effects the outer edges of the beam more strongly than the inner part of the beam. The in-folding effect is greater the wider the spread of particles from the beam centerline, redirecting particles near the edge of the distribution toward the center. Thus, a beam that enters an octupole magnet with a distribution that is wide but thin, such as with a profile distribution exhibiting a wide X-dimension and narrow or thin Y-dimension, will exit the magnet with a spread that is narrower in the X-dimension but only slightly thinned in the Y dimension.

In conventional charged particle beam manipulator systems, an octupole transition may be executed with a single octupole magnet to compress a beam of charged particles in both X and Y directions in the same magnet. However, such conventional uses of octupole magnets in beam paths create a number of difficulties. First, the perpendicular (e.g., X and Y) dimensional transforms are coupled. This means that it is much more difficult to create a square or rectangular beam, compared to a round beam produced from an accelerator with a profile that is approximately circular or random. Second, using a single octupole magnet requires extreme precision in manipulating the beam before the beam enters the octupole magnet. Specifically, both the X and Y phase spaces need to be as identical as possible to obtain a high-quality transform by the octupole magnet.

Various embodiments leverage the shaping effects of octupole magnets by using two octupole magnets with the beam profile adjusted by assemblies of beam-shaping quadrupole magnets that reconfigure the beam to expand the profile distribution in one dimension before the beam enters each octupole magnet. Quadrupole magnets focus beams in one dimension and defocus in the other dimension. The charged particle beam management and control system includes a first assembly of quadrupole magnets configured with magnetic field strengths and separation distances between magnets to expand the beam along one dimension (arbitrarily referred to as along the “X” dimension) before the beam enters the first octupole magnet. The charged particle beam management and control system includes a second assembly of quadrupole magnets that are configured with magnetic field strengths and separation distances between magnets to expand the beam along a perpendicular dimension (arbitrarily referred to as along the “Y” dimension) before the beam enters the second octupole magnet.

Thus, the first assembly of quadrupole magnets and the first octupole magnet preferentially expands and shapes the charged particle beam along one dimension (e.g., along the X dimension), and the second assembly of quadrupole magnets and the second octupole magnet preferentially expands and shapes the beam in the perpendicular dimension (e.g., along the Y dimension). The strength of the quadrupole magnets in each of the first and second assemblies depends on how elongated the beam is upon entering the assembly, how elongated the beam needs to be at the exit, the beam intensity, and the energy distribution of particles in the beam.

The result of manipulating the beam through the two sets of shaping quadrupole magnet assemblies and two octupole magnets is a beam that is shaped into a roughly rectangular profile (e.g., approximately square) at the output of the second octupole magnet. Thus, a beam exiting the accelerator and initial beam path elements with a roughly circular profile may be transformed into a beam with a square or rectangular profile.

The charged particle beam management and control system then allows the square or rectangular beam to expand over a distance (the drift path) before the beam strikes the target. Such beam expansion results from electrostatic repulsion of the particles in the beam, but may also be enhanced or controlled by quadrupole magnet assemblies in the drift path. The amount of beam expansion due to electrostatic repulsion that occurs over the drift path to the target depends on the distance the beam travels, the energy of the beam (i.e., particle mass and velocity), and the electrostatic repulsion forces in the beam, which depends on the charge and mass of each particle in the beam, as ionized hydrogen exhibits greater electrostatic repulsion than ionized deuterium. By controlling magnet field strengths in the two octupole magnets and at least some of the quadrupole magnet assemblies to adjust the profile dimensions of the beam and, in some cases, adjusting the distance from the second octupole magnet to the target, the charged particle beam management and control system can control the beam's profile upon striking the target to approximately match the dimension of the target. Some steering and/or quadrupole magnet assemblies may also be included along the beam expansion path to shape and control beam expansion to better match the target shape and dimensions.

Additionally, quadrupole magnets may be positioned along the drift path with their magnetic fields controlled to either accelerate or retard the amount of beam expansion over the distance. To expand the width and/or height of the beam profile, such quadrupole magnet assemblies may have the magnetic strengths controlled so that the focusing axis effect is weaker than the defocusing axis effect. This magnetic field configuration is effectively the opposite of the magnetic field strength configurations in quadrupole magnets used in beam confinement and beam reshaping occur where the focusing effect is made stronger than the defocusing effects. To control the beam profile shape and degree of expansion along both axes of a square or rectangular profile, three quadrupole magnets may be used for this purpose, with one expanding the beam along a first direction (e.g., along the X axis) and a second expanding the beam along the perpendicular second axis (e.g., along the Y axis), and a third performing further expansion as needed to achieve a desired beam shape and size at the target. Multiple pairs of quadrupole magnets may be used to further expand as well as fine tune the beam profile and spread.

The accelerator may produce a beam of charged particles with a range or spectrum of energies. Therefore, the beam of charged particles exiting and initial beam path elements the accelerator may be directed through an “achromat bend” of a plurality of quadrupole magnets having magnetic strengths controlled to focus the beam and compensate for chromatic dispersion in the particles within the beam.

After the achromat bend, the beam profile may be shaped by the first assembly of quadrupole magnets so that the beam is elongated in one direction (e.g., along the X dimension) and compressed in the perpendicular direction (e.g., along the Y dimension). This sets up the beam for manipulation by the first octupole magnet, the magnetic field of which has a strong centering (or “in-folding”) effect on particles spread out along the first (e.g., X) direction and only a weak effect on particles distributed along the perpendicular (e.g., Y) direction. Thus, the first assembly of quadrupole magnets manipulates the beam so that the first octupole folds particles spread along the first direction of the beam profile toward the center with less effect on particles distributed along the perpendicular direction. Then the second assembly of quadrupole magnets elongates the beam profile along the perpendicular (e.g., Y) direction and compresses the beam along the first (e.g., X) direction before the beam enters the second octupole. Again the magnetic field configuration of the second octupole magnet produces a similar a strong redirecting (“in folding”) effect on particles near the wings of distribution along the Y direction and a lesser effect on particles along the X direction. The combination of in-folding beam particles in two perpendicular directions through two octupole magnets results in an approximately rectangular or square profile.

The use of two octupoles to perform the beam transforms allows the beam manipulator system to control the X and Y beam directions independently. This enables the system to control the beam spread differently in the X and Y dimensions. This enables the generation of virtually any rectangular beam profile at the target, including square. This also simplifies generating the correct beam phase space before the octupole magnets.

The octupole magnet does the transform resulting in a rectangular beam profile, the plurality of quadrupole magnet assemblies to set up beam conditions properly before each octupole magnet, and thus contribute to the overall beam configuration. These quadrupole magnet assemblies have magnetic field strengths that are regulated by a control system to control linear beam dynamics as described herein.

As noted above, the nonlinear beam transformations in the two octupole magnets and associated quadrupole magnet assemblies are done while the beam is relatively compact, such as about 2-20 mm across. The large size of the beam at the target (i.e., with dimensions approximately matching those of the target) is achieved by creating a small square or rectangular beam profile in the two octupole magnets and simply allowing the beam to expand as it travels a distance (referred to as the “drift path”) before striking the target. For example, the drift path may be nine to ten meters in length. Also, by adjusting the strength of the quadrupole magnets the system can control how compact the beam is at the start of the drift path. By varying the location of the target with respect to the second quadrupole magnet (i.e., adjusting the drift path length) and the strength of the quadrupole magnets, various embodiments can produce a wide range of beam sizes at the target.

In an example embodiment, the charged particle beam management and control system includes five quadrupole magnet assemblies located before the first octupole to prepare the beam and two quadrupoles located between the octupoles to manipulate the beam and a final quadrupole after the last octupole to convert an elliptical profile beam back to a roughly round profile beam. The number of these manipulating magnets may be different in various implementation configurations. The various magnet assemblies are powered by one or more controllable power units that apply electrical power to individual magnets subject to signals from a control system, as described below.

While the system of magnets functions to transform the charged particle beam into a rectangular or square profile with dimensions approximately matching those of the target, stray particles are inevitable due to variations in particle energies, magnetic field interactions, and electrostatic repulsion forces. To accommodate this, the charged particle beam management and control system may include one or more collimators positioned along the path of the beam.

Such collimators may be shaped and positioned so as to remove particles outside of a desired beam distribution profile, thus helping to match the beam profile to the target shape and dimensions. Collimators may also serve to capture stray particles that would otherwise strike a surface within the overall system, which could lead to nuclear activation of some materials and result in undesirable levels of radioactivity after extended use.

Various embodiments include a control system for dynamically adjusting the magnetic field strengths generated by the octupole magnets and quadrupole magnet assemblies so as to maintain the shape, dimensions, and position of the beam at the target. The control system components include a beam imaging system or detector at/near the target and a beam optimization system that executes software instructions configured to provide control signals to the one or more power units that power various magnets of the charged particle beam management and control system.

To maintain the desired uniformity of the beam profile at the target during an extended run, the charged particle beam management and control system employs a series of controllable quadrupole magnets strategically placed before and between the octupole magnets. Individual magnets within the quadrupole and octupole magnets are supplied with electrical power by the one or more one or more power units. These power units may respond to command signals from the control system to dynamically adjust the power applied to individual magnets within selected quadrupole and octupole magnets to control magnetic field strengths. This enables the control system to fine-tune the beam's phase space, profile, and direction responsive to information provided by the beam imaging system. By dynamically adjusting the magnetic field strengths of selected quadrupole magnet assemblies, the system can compensate for variations in the beam's initial conditions as well as system and component variations, allowing the charged particle beam management and control system to maintain a high-quality, uniform beam profile across different target sizes and shapes and over the duration of an extended target irradiation session.

The beam imaging system includes a sensor that detects particles in the beam at or near the target, such as particles around the edges of the beam profile. This sensor provides information regarding the profile and distribution of the beam at or near the target. Information from this sensor may be processed, or provided to the control system for processing, to quantify the beam quality, such as the uniformity of particles within and across the profile of the beam as well as dimension of the beam profile, e.g., squareness or compliance with the shape and size of the target.

In some embodiments, the sensor may be a Beam Induced Fluorescence Monitor (BIFM). An advantage of a BIFM sensor is that this type of sensor does not remove particles from the beam. In a BIFM, the beam of ions passes through a thin gas, and the charge of the high energy ions excites the gas causing fluorescence that can be imaged by a camera or image intensifier. The vast majority of the beam particles pass through the BIFM without striking gas molecules, and therefore the BIFM does not impact beam quality or remove a significant number of particles from the beam. Exciting the gas to fluoresce does transfer a few electron volts (eV) of energy from the beam to the gas, but in a high-energy beam (e.g., each particle has around 50 MeV of energy), this energy loss is insignificant.

Examples of other types of sensors that may be used to analyze the beam location, shape and spread in various embodiments include a Beam Induced Ionization Monitor (BIIM), a scintillation screen, a radiation probe, a wire scanner a high-accuracy radiation probe (HARP), a thermal imaging sensor, and radiation detectors in combination with a collimator. A BIIM sensor may detect the ionization of gas atoms or molecules as high-energy ions pass through or near the gas. Scintillation screen sensors may detect (e.g., via image intensifiers or cameras) scintillation flashes as beam particles pass through a thin screen of a scintillation material. Radiation probes sense the radiation generated by the beam and provide information regarding the radiation pattern. Wire scanners and HARP sensors detect the charge collected on wires as charged particles pass through a grid or array of fine wires. Radiation detectors combined with a collimator may detect particles colliding with the collimator, such as in scintillation materials that are positioned on the collimator around the collimating opening.

The beam optimization system includes a computer or processing system executing a software algorithm that analyzes the image and the beam quality information received from the beam imaging system and controls the charged particle beam management and control system to maintain or improve beam quality at the target. The beam optimization system dynamically adjusts beam quality by issuing commands to one or more power units to adjust the strengths and orientations of the magnetic fields produced by selected magnet assemblies in the charged particle beam management and control system. The optimization software algorithm compares the beam delivered to the target to an arbitrary function and generates magnet control commands to adjust the magnetic field strength of selected magnets so as to cause the beam distribution to converge to the function. The algorithm executed by the computer or processing system may be a global optimizer that tries different combinations of magnet settings and evaluates the resulting beam quality, selecting those settings that improve beam quality.

The dynamic adjustments may be made using a moderately slow control loop of beam analysis leading to adjustment control signals, with adjustments implemented on times scales on the order of minutes. The beam optimization system runs continuously during an irradiation session to correct for beam profile and direction changes resulting from variations in the beam source (i.e., the accelerator) and the changes in the overall system such as due to temperature changes in various components within the system.

Various embodiments may also include safety features built into the control system, such as software executing in the control system that will shut down the accelerator if the beam is out of a prescribed area, such as off the target. The control system may also keep track of long-term drifts in the system and warn operators of approaching trouble before it happens. For example, a BIFM near the target that supplies beam quality information to the beam optimization system may also be used to detect and signal problems with the beam dynamics. Other types of sensors described above may be used for this purpose as well.

In some embodiments, the processing performed by the beam optimization system may be implemented using machine learning techniques for predictive modeling of beam behavior under various conditions. By training a machine learning system on the response of the beam quality, as measured by the beam imaging system, to various adjustments in the power applied to various magnets in the system, the machine learning system may be trained to adaptively adjust quadrupole magnetic field strengths in response to information received from the beam imaging system.

While beam manipulations by the charged particle beam management and control system are described as two-dimensional problems, the system controls the beam in four-dimensions. This is because in each dimension there are actually two degrees of freedom, namely velocity and position. The extra two degrees of freedom of particle velocity are controlled by manipulating the phase advance between the two octupoles. In an example embodiment, the charged particle beam management and control system may accomplish this using a plurality of quadrupole magnets (e.g., five magnets) located before the first octupole magnet to prepare the beam for that magnet and two or more quadrupoles located between the first and second octupole magnets to manipulate the beam before shaping by the second octupole magnet. A final quadrupole may convert the elliptical beam exiting the second octupole magnet back to a roughly round beam. The number and locations of these manipulating magnets may be different from this example.

Various embodiments provide methods for controlling and directing a beam of charged particles on a target. Such methods may include passing a charged particle charged particle beam output by an accelerator through an achromat bend that includes a plurality of quadrupole magnets having magnetic strengths controlled to focus the beam and compensate for chromatic dispersion in the charged particles received from the accelerator. The beam may then be passed through a first assembly of quadrupole magnets in which the orientation and magnetic field strength are configured to cause the beam to expand preferentially in a first profile direction (e.g., X direction) and contract in a second profile direction perpendicular to the first direction (e.g., Y direction). The beam exiting the first assembly of quadrupole magnets is then passed through a first octupole magnet that is configured to redirect particles towards a center portion of the beam as described above.

After exiting the first octupole magnet the beam is passed through a second assembly of quadrupole magnets in which the orientation and magnetic field strength are configured to cause the beam to expand preferentially in the second direction (e.g., Y direction) and contract in the first direction (e.g., X direction). After exiting the second assembly of quadrupole magnets the beam is passed through a second octupole magnet that is also configured to redirect particles towards the center portion of the beam, as described above.

As part of shaping and controlling the beam profile, one or more collimators are positioned in the beam path to trim out stray particles outside the desired beam profile (e.g., outside of a square or rectangular profile). For example, a first collimator may be positioned along the beam path after the first octupole magnet to trim stray particles along the first direction (e.g., X direction), and a second collimator may be positioned along the beam path after the second octupole magnet to trim stray particles along the second direction (e.g., Y direction).

After exiting the second octupole magnet, the beam is allowed to expand before striking the target. As described above, the expansion of the beam profile may be caused by a combination of isotropic electrostatic repulsion and quadrupole shaping magnet assemblies (e.g., two or more quadrupole magnets) along the beam path.

To accommodate changes in the system components due to temperature and system variability, the system may include a control computing system that receives information from sensors positioned near the target regarding at least one of a uniformity, shape, size, or position of the beam at or near the target, and adjusts magnetic field strengths in one or more magnets within the system so as to maintain the beam on the target with the desired shape and distribution.

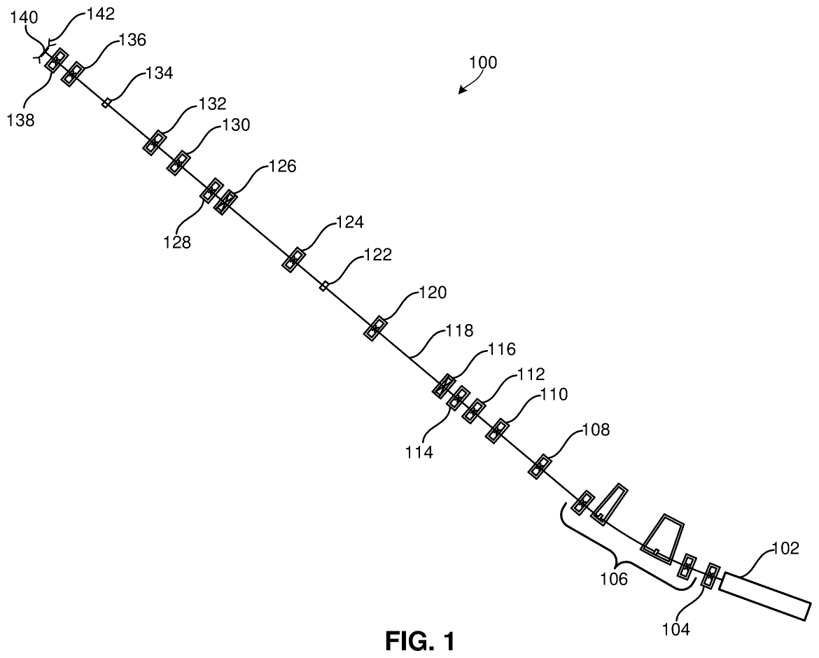

FIG. 1 illustrates examples of magnets and other components that may be used in various embodiments. For ease of illustration, the evacuated tube or beam pipe 118 through which the charged particle beam traverses the overall system is shown in FIG. 1 as a solid line, leaving out details of the tube and associated vacuum equipment.

A charged particle beam management and control system 100 may receive a charged particle beam from an accelerometer 102, passing the beam through one or more focusing magnets 104. The beam may then be directed into an achromat bend 108 that includes a plurality of bending magnets and quadrupole magnets having magnetic strengths and orientations controlled to focus the beam into the beam path of the charged particle beam management and control system 100 and compensate for chromatic dispersion in the charged particles received from the accelerator. An achromat bend 106 is optional, but may be useful for bending the direction of the beam exiting from the accelerator toward the target without introducing chromatic dispersion. An achromat bend may include a mix of multiple different magnet assemblies configured to control dispersion while accomplishing the desired change in beam direction. In an embodiment, the achromat bend 106 may include a 6-degree dipole magnet, a 14-degree dipole magnet, five quadrupole magnets, a 14-degree dipole magnet, and a 6-degree dipole magnet.

A first assembly of quadrupole magnets 108, 110, 112, 114 is positioned in the path of the beam of charged particles exiting from the achromat bend. The first assembly of quadrupole magnets are oriented and energized to produce magnetic fields configured to perform non-linear transforms on the beam. These magnet assemblies cause the beam of charged particles to expand preferentially in a first direction (e.g., X) and contract in a second direction (e.g., Y) perpendicular to the first direction, in which the first and second directions are perpendicular to the direction of travel of the beam.

A first octupole magnet 116 is positioned after the first assembly of quadrupole magnets 108, 110, 112, 114 along the path of the beam. As discussed above, the first octupole magnet 116 is configured to produce magnetic fields that redirect charged particles towards a center portion of the beam. Thus with the entering beam expanded in a first direction (e.g., X), the first octupole magnet 116 effectively squares the beam along the first direction, while having minimal effect on the beam in the perpendicular direct (e.g., Y).

After the first octupole magnet 116, another quadrupole magnet 120 is oriented and energized to partially expand the beam in the second direction (e.g., Y). A first collimator 122 is positioned, shaped, and configured to trim out stray particles within the beam profile along the first direction (e.g., X), further squaring the beam along that direction. The trimmed beam is then passed through another quadrupole magnet 124 that is oriented and energized to further expand the beam in the second direction (e.g., Y). This second assembly of quadrupole magnets 120, 124, cause the beam of charged particles to expand preferentially in the second direction (e.g., Y) and contract in the first direction (e.g., X).

The beam then passes through the second octupole magnet 126, which is also configured to produce magnetic fields that redirect particles toward the center portion of the beam. Thus, with the entering beam expanded in the second direction (e.g., Y), the second octupole magnet 126 effectively squares the beam along the second direction while having minimal effect on the beam in the perpendicular first direction (e.g., Y).

After leaving the second octupole magnet 126 may pass through a third assembly of quadrupole magnets 128, 130, 132 that are oriented and energized to shape and control the size of the beam before the beam is allowed to expand through a final drift path before the target 148.

The shaped beam may then pass through a second collimator 134 that is positioned, shaped, and configured to trim out stray particles within the beam profile along the second direction (e.g., Y), further squaring the beam along that direction. As noted above, the 122, 134 collimators may be shaped and positioned so as to remove particles outside of a desired beam distribution profile. The collimators also capture stray particles that would otherwise strike a surface within the overall system, which could lead to activation of some materials, resulting in undesirable levels of radioactivity after extended use. A major purpose of the collimators is to control where the beam losses occur. In nonlinear beam transformations within the quadrupole magnets 108, 110, 112, 114, 120, 124, 128, 130, 132, the development of tails in the beam profile and some beam losses are unavoidable. Collimators can be used to control where those losses occur to enable managing such losses. Collimators also have the effect of providing a clearer beam profile upon reaching the target.

In some embodiments, the collimators 122, 134 may include a metal ring with a square hole that defines the desired beam size and shape at the location of the collimator along the beam path. The collimator blocks or captures particles that are outside the square hole and allows only the particles that are inside the hole to pass through. Other forms of collimator may be used, such as collimators positioned along an edge of the beam, such as locations where particles tend to stray from the main beam centerline, such as due to complex magnetic interactions that may be present in some magnet assemblies.

In some embodiments, the collimators 122, 134 may be made of a graphite layer over a copper under structure. The graphite layer serves as the beam-facing material that interacts with the beam particles. The copper under structure serves as a heat sink and a mechanical support for the graphite layer. The graphite layer has a low activation cross-section, meaning that it does not become highly radioactive when exposed to the beam, and the resulting radioactive isotopes have a short half-life and thus enable access to the system soon after shutdown. Copper in the understructure has a higher activation cross-section, meaning that it becomes more radioactive when exposed to the beam. However, the copper understructure is shielded by the graphite layer from direct beam exposure, and thus its radioactivity is reduced. The combination of graphite and copper provides a collimator design that minimizes radioactivity exposure to the user and the environment while maintaining high thermal and mechanical performance.

The beam expansion portion of the system is sized and configured to allow the beam of charged particles to expand due to electrostatic repulsive force of the positively charged particles in the beam before striking the target 140. In some embodiments, the system may include additional quadrupole magnets 136, 138 that are oriented and energized to control the size of the beam as it expands in profile to better match the dimensions of the target.

The charged particle beam management and control system 100 also includes a target station 142, including mechanisms for holding and loading targets into a target positioning device that is configured, such as with clamps, mounting brackets, or a sleeve or pocket to hold the target 140 for irradiation in the path of the beam of charged particles. The use of a target station that can hold and load targets into the beam path may be useful for enabling the irradiation of multiple targets in a given accelerator run. Such a target station 142 that can sequentially insert targets into and remove targets from the beam path may enable controlling the irradiation exposure on any one target, which can be useful for controlling the specific isotope generated (e.g., minimizing number of double activations) while producing sufficient amounts of the specific isotope for production needs.

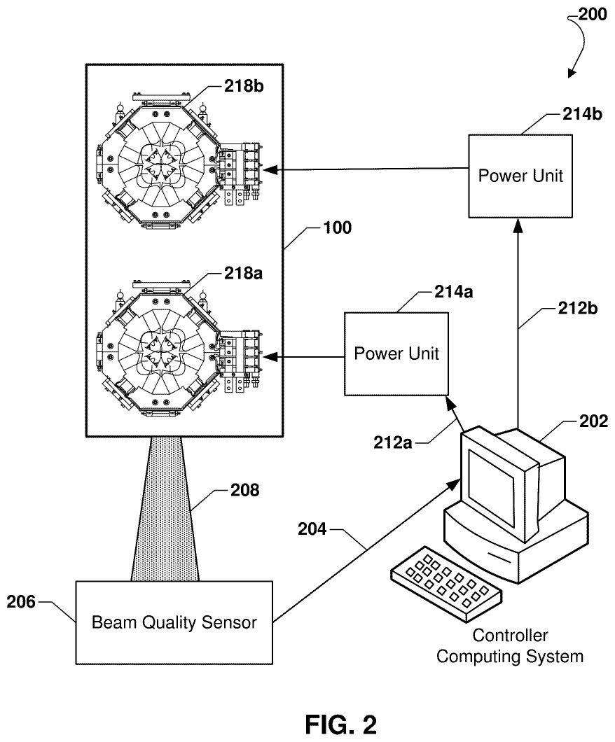

Referring to FIG. 2, the charged particle beam management and control system may include a control system 200 for controlling the magnetic field strengths of various magnets within the system. The control system 200 may include a controller computing system 202 that is connected by a data cable to receive beam quality information 204 from a beam quality sensor 206 that is configured to sense and quantify size, shape, and position information regarding the charged particle beam 208 near the target. The controller computing system 202 may be programmed with processor-executable instructions (e.g., software) that analyze the beam quality information 204, such as comparing the information to a desired function and issuing control signals 212a, 212b to one or more power units 214a, 214b that supply electric power to magnets within the first and second assemblies of quadrupole magnets 218a and magnets within the first and second octupole magnets 218b. The one or more power units 214a, 214b are configured through circuitry and/or a programmable logic controller (PLC) to respond to control signals 212a, 212b received from the controller computing system 202 to adjust the electric power applied to selected the magnets within system magnets 218a, 218b (e.g., some of the magnets within the quadrupole magnets 112, 114, 116, 118, 120, 120, 124, 128, 130, 132, 136, 138 and/or some of the magnets within the octupole magnets 116, 126). The one or more power units may adjust the electrical power applied to individual magnets in response to control signals 212a, 212b according to preconfigured control rules (e.g., may implemented in a PLC). Basically, the controller computing system 202 executes software that responds to shifts in the beam 208 as sensed by the beam quality sensor 206 by controlling the power units 214a, 214b that adjust power to selected magnets within the system so as to redirect and/or refocus the beam to maintain or increase beam quality at the target.

The beam quality sensor 206 may be a BIFM sensor that senses locations of particles in the beam, such as by imaging fluoresces that occur when beam particles pass through a thin gas in the BIFM. Imaging such fluoresces events can provide information regarding the distribution and number of beam particles that are outside the periphery of the target, thereby providing direction information on the uniformity, shape, size, and/or position of beam particles at or near the target. The BIFM sensor may include electronics (which may include processors) that transform the particle detections into beam quality (e.g., uniformity, shape, size, or position) in a data format suitable for communicating to the controller computing system 202.

The controller computing system 202 includes a processing system that executes processor-executable software instructions that cause the computing system to receive the beam quality information (e.g., uniformity, shape, size, or position of the beam) from the beam quality sensor 206, determine based on the received information adjustments to magnetic field strengths of selected magnets within the various assemblies of quadrupole magnets 112, 114, 116, 118, 120, 120, 124, 128, 130, 132, 136, 138 and the octupole magnets 116, 126 to maintain beam uniformity and profile shape, and output control signals 212a, 212b to the one or more power units 214a, 214b to make adjustments to selected magnetic field strengths maintain beam uniformity and shape. By controlling the various assemblies of magnets, the system may control the beam profile shape to match an arbitrary target profile.

Additionally, the controller computing system 202 may receive information from beam positioning monitors and control power applied to steering magnet assemblies, such as two small dipole magnet assemblies, to keep the beam in the center of the beam pipe and the center of the target. Such steering magnet assemblies may be similar to magnets used in conventional accelerator beam lines.

In some embodiments, a combination of dipolar and quadruple fields may be used in conjunction with the multipolar field structure within one or both of the octupole magnets 116, 126 to enhance beam transformation. This may be achieved by strategically placing quadruple magnets before (e.g., as separate magnets) or between pole pieces (e.g., within the octupole magnets) to create spatial gradients that interact with each other through subtle adjustments made during operations by the control system 200. For example, additional magnet assemblies may be used to generate more complex magnetic fields, such as 12-pole, 16-pole, 20-pole, etc. fields.

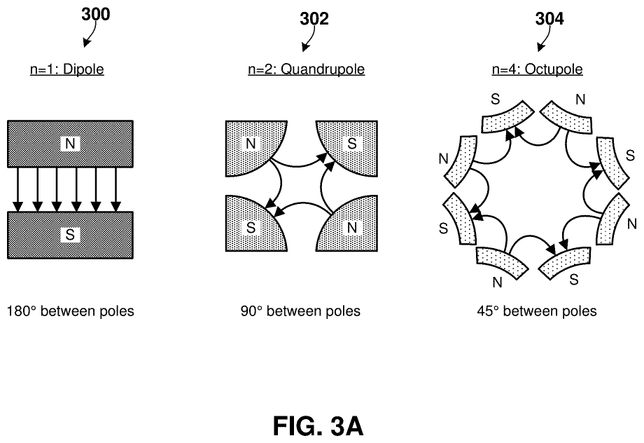

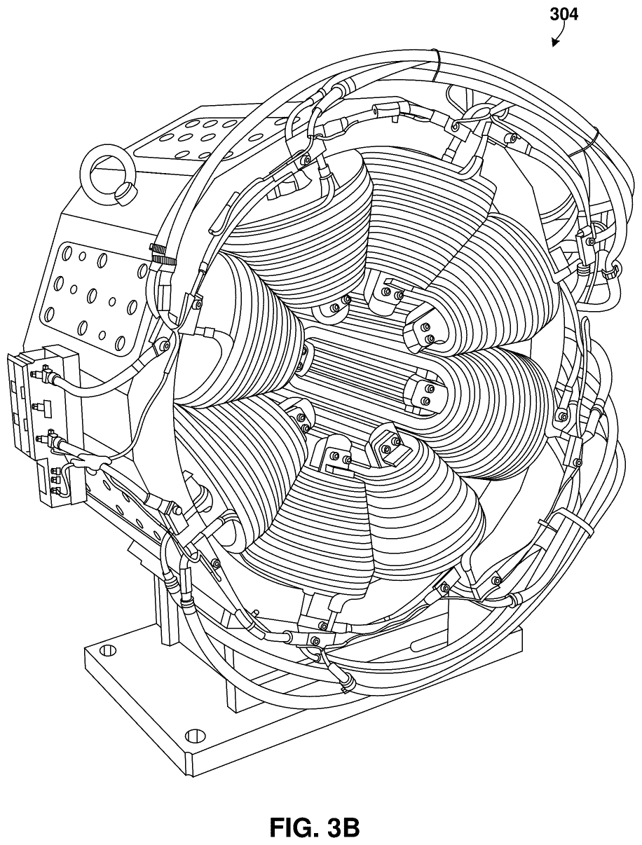

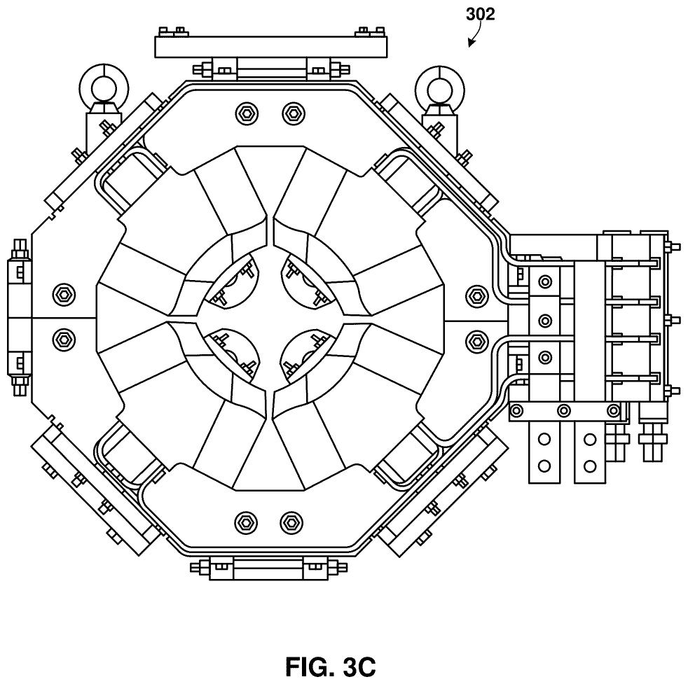

FIGS. 3A-3C illustrate various magnet assemblies that may be used in various embodiments. FIG. 3A shows notional diagrams of dipole magnets 300, quadrupole magnets 302, and octupole magnets 304. FIG. 3B shows an example of an octupole magnet 304. FIG. 3C show an example of a quadrupole magnet 302.

Referring to FIG. 3A, dipole magnets 300 include a north and south pole with the magnetic field flowing linearly between the poles. The linear magnetic field generated by dipole magnets 300 may be used for steering a charged particle beam, such as to match a bend in the beam path.

Quadrupole magnets 302 include alternating north and south poles disposed around a beam centerline. As illustrated, the non-linear magnetic field lines flow between the north and south poles, resulting in squeezing a charged particle beam along one direction.

Octupole magnets 304 include four north magnetic poles interspersed by four south magnetic poles, resulting in the illustrated non-linear magnetic field lines. As described herein, a charged particle beam passing through the non-linear magnetic field is transformed so that charged particle particles located far from the centerline of the beam are folded back toward the beam centerline while having minimal redirection on particles located near the beam centerline.

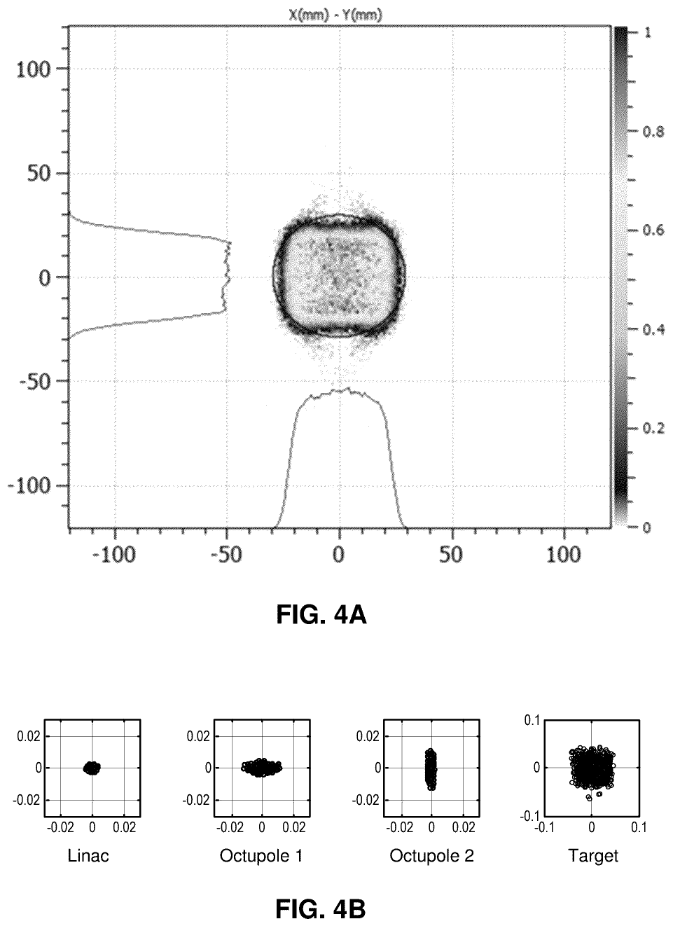

FIGS. 4A and 4B are graphs of charged particle beam profiles at various locations within the charged particle beam management and control system in various embodiments.

FIG. 4A is a two-dimensional map (X vs. Y) of intensity of the profile of the beam at the target resulting from the beam manipulations provided by the charged particle beam management and control system according to some embodiments.

FIG. 4B is a series of graphs showing the profile of a charged particle beam exiting the accelerator (“Linac”) before entering the first octupole magnet, before entering the second octupole magnet, and then at the target. As described above, FIG. 4B shows how the beam exiting the accelerator may be concentrated into a narrow, essentially circular beam, which may have too high an energy density for the target to survive. The figure also shows how the first assembly of quadrupole magnets may reshape the beam to be expanded along the X direction prior to entering the first octupole magnets and then reshape the resulting beam along the Y direction prior to entering the second octupole magnets. The result of these two perpendicular beam transformations transforms the circular input beam into a square profile (in the illustrated example), which, after expansion through the drift path arrives at the target essentially square and approximately matching the square dimension of the target.

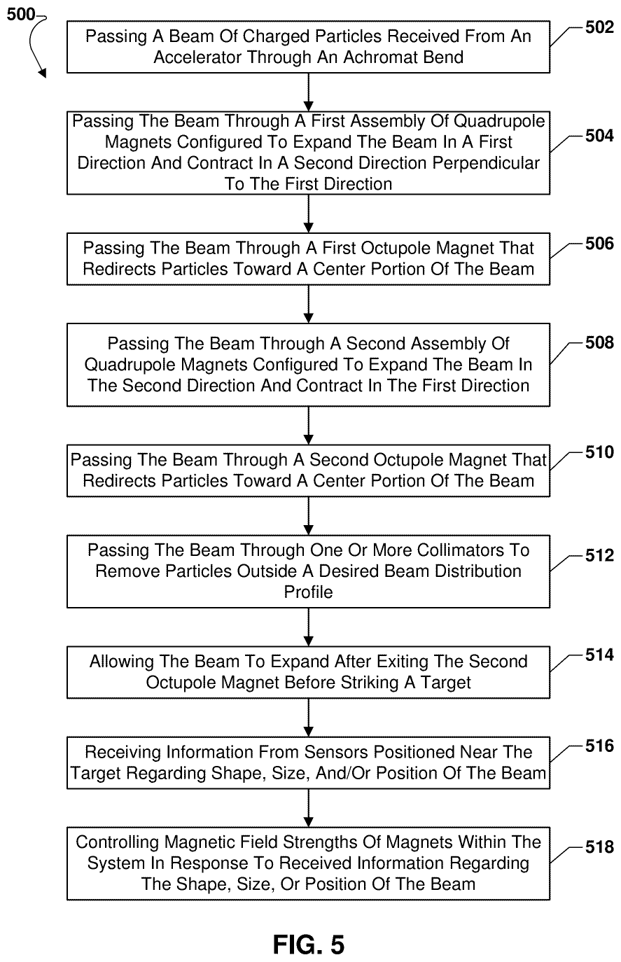

FIG. 5 illustrates an example method for controlling a beam of charged particles according to some embodiments. With reference to FIGS. 1-5, the method 500 may be implemented in a charged particle beam management and control system 100 as described herein. Means for performing functions of the method 500 may include the components and subsystems described with reference to FIGS. 1-4. In order to encompass the alternative configurations enabled in various embodiments, the hardware implementing the method 500 is referred to herein as a “system.”

In block 502, the processor may perform operations including passing a beam received from an accelerator through an achromat bend comprising a plurality of quadrupole magnets having magnetic strengths controlled to focus the beam and compensate for chromatic dispersion in the charged particles received from the accelerator. In some embodiments, one or more quadrupole magnets may be used in the achromat bend section to compensate for chromatic dispersion within charged particle beams exiting from the accelerator by focusing particles with different energies and wavelengths into a beam with sufficient uniformity to enable precise control by the rest of the system.

In block 504, the system may perform operations including passing the beam received from the achromat bend through a first assembly of quadrupole magnets in which the orientation and magnetic field strength are configured to cause the beam to expand preferentially in a first direction and contract in a second direction perpendicular to the first direction, wherein the first and second directions are perpendicular to a direction of travel of the beam. As described, the first assembly of quadrupole magnets may be configured and arranged along the beam path to generate an adjustable magnetic field gradient that expands the beam's profile preferentially in the X direction (parallel to one side of the target) while contracting the beam perpendicular to it.

In block 506, the system may perform operations including passing the beam after exiting the first assembly of quadrupole magnets through a first octupole magnet that is configured to redirect particles toward a center portion of the beam. The first octupole magnet is configured to produce magnetic fields that effectively fold inward particles at the edges of the beam distribution by redirecting them toward the central region through high-order multipolar field configurations. As the incoming beam was expanded in one direction (e.g., the X direction), the first octupole magnet has a greater redirecting effect on particles along that direction.

In block 508, the system may perform operations including passing the beam after exiting the first octupole magnet through a second assembly of quadrupole magnets in which the orientation and magnetic field strength are configured to cause the beam to expand preferentially in the second direction (e.g., Y direction) and contract in the first direction (e.g., X direction). The second assembly of quadrupole magnets positioned along the beam path manipulates particle trajectories so that particles are spread along the second direction to set up the beam for manipulation by the second octupole magnet.

In block 510, the system may perform operations including passing the beam after exiting the second assembly of quadrupole magnets through a second octupole magnet that is configured to redirect particles toward the center portion of the beam. The second octupole magnet redirects particles in the beam in the same manner as the first octupole magnet, but because the incoming beam was expanded in the second (e.g., Y direction) and compressed in the first (e.g., X direction), the redirecting effects are preferentially on particles spread along the Y direction). This can have the effect of approximately squaring the beam along the Y direction.

In block 512, the system may perform operations including passing the beam through one or more collimators along the path of the beam to remove particles outside of a desired beam distribution profile. In some embodiments, one or more collimators (e.g., 122) may be positioned after the first octupole magnet and shaped and positioned so as to remove from the beam particles outside of desired profile along the first (e.g., X direction) and one or more collimators (e.g., 134) may be positioned after the second octupole magnet and shaped and positioned so as to remove from the beam particles outside of desired profile along the second (e.g., Y direction). The collimators may remove particles from the beam that the first and second octupole magnets did not redirect toward the beam's center, such as due to various magnetic field effects or the particles entering too far from the center to be sufficiently redirected into the desired profile. It should be noted that the collimators may be positioned before, after, or in between magnets within the first and second assemblies of quadrupole magnets in various system configurations.

It should be appreciated that collimators may not be required and therefore the operations in block 512 depending on various factors. For example, collimators may be unnecessary depending on the beam profile exiting the accelerator and the desired distribution at the target. In implementations that provide a “clean” profile from the accelerator, the generation of “tails” of particles outside the main beam profile may be minimal, in which case the need for colimitations would be minimal. However, in implementations in which the accelerator accelerates ions to high energies, producing an intense beam, the profile of the beam exiting the accelerator may not be so “clean” due to space charge effects in the accelerator. Thus, in embodiments producing high intensity charged particle beams, collimators may be important components and the operations in block 512 may be included.

In block 514, the system may allow the beam to expand after exiting the second octupole magnet before striking a target. As described, this expansion may be achieved by allowing the beam to travel a distance (drift path) so that electrostatic repulsion of the charged particles expands the beam isostatically. In some embodiments, one or more quadrupole magnets may be included along the beam path before the target to increase and provide some control over the expansion in each of the first and second directions. Including such quadrupole magnets with magnetic field strengths controlled by a control system as described, may enable the system to adjust and maintain the profile dimension of the beam at the target to match the dimensions of different sized targets without changing the length of the drift path.

In block 516, the system may perform operations including receiving information in a computing system from one or more sensors positioned near the target regarding at least one of a uniformity, shape, size, or position of the beam at or near the target. As described, the sensor(s) at/near the target may be one or more Beam Induced Fluorescence Monitors (BIFM) that sense fluoresce of gas molecules when charged particles pass through a thin gas, enabling imaging of the beam by a camera or other light sensor. As described above, other types of sensors may also be used and provide information to the computing system on beam uniformity, shape, size, or position at or near the target.

In block 518, the system may perform operations including controlling magnetic field strengths of magnets within the system in response to received information regarding the uniformity, shape, size, and/or position of the beam. As described with reference to FIG. 2, a controller computing system may use the information regarding beam uniformity, shape, size, and/or position in an algorithm that is programmed or trained (e.g., using machine learning technology) to adjust the electrical power applied to, and thus the magnetic field strength of selected magnets within the system so as to cause the beam to conform to a desired uniformity, shape, size, and/or position function. To do this, the controller computing system may be programmed or trained to issue commands to one or more power units that control the electrical power applied to each magnet and respond to received commands by adjusting to applied electrical power according to preconfigured control rules.

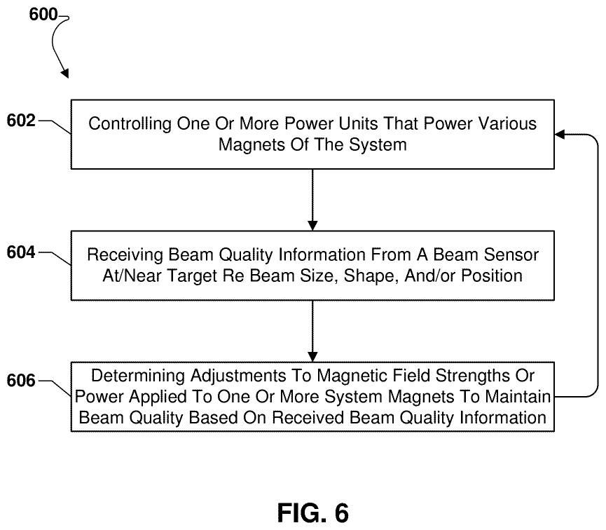

FIG. 6 illustrates an example method 600 that may be performed in a system control computing system for adjusting system magnet fields to maintain beam quality on the target of a beam of charged particles according to some embodiments. With reference to FIGS. 1-6, the method 600 may be implemented in a charged particle beam management and control system as described herein. Means for performing functions of the method 600 may include the components and subsystems described with reference to FIGS. 1-3C. In order to encompass the alternative configurations enabled in various embodiments, the hardware implementing the method 600 is referred to herein as a “computing system.”

In block 602, the computing system may perform operations including controlling one or more power units that power various magnets of the system.

Again, the controller computing system may be programmed or trained to issue commands to one or more power units that control the electrical power applied to each magnet and respond to received commands by adjusting to applied electrical power according to preconfigured control rules. Initially, a user may input control inputs to the computing system to adjust the beam quality and position to focus the beam on the target with a profile and uniformity matching the target and with a beam intensity suitable for achieving the goals for the irradiation session (e.g., generating a desired percentage of nuclear activations). Once the beam quality and position are on target, an irradiation session may be started.

In block 604, the computing system may perform operations including receiving beam quality information from a beam sensor at or near the target regarding beam uniformity size, shape, and/or position. As described, the information may be received from a BIFM sensor located at or near the target.

In block 606, the computing system may perform operations including determining adjustments to magnetic field strengths or power applied to one or more system magnets to maintain beam quality based on the received beam quality information. Based on the determined adjustments, the computing system may control the magnetic field strength of one or more system magnets within any of the first assembly of quadrupole magnets, the second assembly of quadrupole magnets, the first octupole magnet, or the second octupole magnet in response to the received information regarding the uniformity, shape, size, or position of the beam at or near the target to maintain a predetermined threshold of the beam striking the target. Again as described, the computing system may be configured with software to execute an algorithm that adjusts the electrical power applied to selected magnets within the system so as to adjust magnetic fields in selected locations within the system to cause the beam to conform to a desired uniformity, shape, size, and/or position function at the target.

In some embodiments, the algorithm used in the operations in block 606 may be an optimization algorithm, such as one or more algorithms in the MATLAB Global Optimization toolbox. For example, the algorithm used in block 606 may minimize an arbitrary function of a vector f(x) in which the function being minimized is the sum of the square of the difference between the beam distribution and a target function of the desired position, shape, dimensions, etc. of the beam at the target. The vector “x” may be the magnetic settings of some of the magnet coils within the system. This vector may include 20 or more dimensions to encompass the various magnet coils in the system that can be adjusted during operation. For example, the fminsearch( ) function in MATLAB may be used for this purposes because it does not need to know the derivatives of the parameters associated with the system responses to adjustments in current applied to various magnet coils.

To adjust magnetic fields in block 606, the computing system may issue commands to one or more power units that control the electrical power applied to system magnets, with the power units equipped, such as with one or more PLCs, to respond to received commands by adjusting the applied electrical power according to preconfigured control rules.

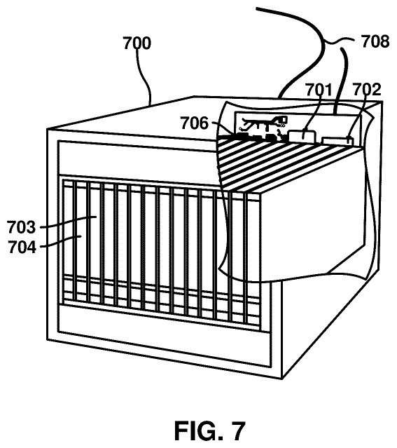

Various embodiments (including, but not limited to, embodiments described above with reference to FIGS. 1-6) may be implemented in system control computing systems, such as any of a variety of generalized or specialized computing systems, an example of which in the form of a server computing system 700 is illustrated in FIG. 7. A server computing system 700 typically includes one or more multicore processor systems 701 coupled to volatile memory 702 and a large capacity nonvolatile memory, such as a non-volatile disk drive 704. The processing systems 701 may include or be coupled to specialized processors 703 configured to perform calculations involved in neural network processing and machine learning, such as graphical processing units (GPU), neural network processors, and the like. In some implementations, multiple processing systems and memory units 704 may be implemented within the computing system 700. The server computing system 700 may also include network access ports 706 coupled to the multicore processor assemblies 701 for establishing network interface connections with a network 708, such as a local area network, the Internet, and other networks.

Computer program code or “program code” for execution on a programmable processor for carrying out operations of the various embodiments may be written in a high-level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor.

By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Combinations of the above are also included within the scope of non-transitory computer-readable and processor-readable media.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of controlling a beam of charged particles (“beam”) to produce a uniform beam shape at a target, comprising:
passing a beam received from an accelerator through a first assembly of quadrupole magnets in which the orientation and magnetic field strength are configured to cause the beam to expand preferentially in a first direction and contract in a second direction perpendicular to the first direction, wherein the first and second directions are perpendicular to a direction of travel of the beam;
passing the beam after exiting the first assembly of quadrupole magnets through a first octupole magnet that is configured to redirect particles towards a center portion of the beam;
passing the beam after exiting the first octupole magnet through a second assembly of quadrupole magnets in which the orientation and magnetic field strength are configured to cause the beam to expand preferentially in the second direction and contract in the first direction;
passing the beam after exiting the second assembly of quadrupole magnets through a second octupole magnet that is configured to redirect particles towards the center portion of the beam; and
allowing the beam to expand after exiting the second octupole magnet before striking a target.

2. The method of claim 1, further comprising passing the beam through one or more collimators along the path of the beam to remove particles outside of a desired beam distribution profile.

3. The method of claim 1, further comprising:
receiving information in a computing system from sensors positioned near the target regarding at least one of a uniformity, shape, size, or position of the beam at or near the target; and
controlling by the computing system a magnetic field strength of one or more system magnets within any of the first assembly of quadrupole magnets, the second assembly of quadrupole magnets, the first octupole magnet, or the second octupole magnet in response to the received information regarding the uniformity, shape, size, or position of the beam at or near the target to maintain a predetermined threshold of the beam striking the target.

4. The method of claim 3, wherein receiving information in the computing system from sensors positioned near the target comprises receiving information from a beam-induced fluorescence monitor positioned near the target.

5. The method of claim 3, further comprising passing the beam through a third assembly of quadrupole magnets after exiting the second octupole magnet with magnetic strengths of the third assembly of quadrupole magnets adjusted by the control system to control a degree of expansion of the beam before striking the target.

6. The method of claim 1, further comprising passing the beam through an achromat bend comprising a plurality of quadrupole magnets having magnetic strengths controlled to focus the beam and compensate for chromatic dispersion in the charged particles received from the accelerator.

7. A system for directing a beam of charged particles (“beam”) onto a target, comprising:
a first assembly of quadrupole magnets positioned in a path of the beam exiting from an accelerator, wherein the first assembly of quadrupole magnets are oriented and energized to produce magnetic fields configured to cause the beam to expand preferentially in a first direction and contract in a second direction perpendicular to the first direction, wherein the first and second directions are perpendicular to the direction of travel of the beam;
a first octupole magnet positioned after the first assembly of quadrupole magnets along the path of the beam, wherein the first octupole magnet is configured to produce magnetic fields that redirect charged particles towards a center portion of the beam;
a second assembly of quadrupole magnets position after the first octupole magnet along the path of the beam, wherein the second assembly of quadrupole magnets are oriented and energized to produce magnetic fields configured to cause the beam to expand preferentially in the second direction and contract in the first direction;
a second octupole magnet positioned after the second assembly of quadrupole magnets along the path of the beam, wherein the second octupole magnet is configured to produce magnetic fields that redirect particles towards the center portion of the beam; and
a beam expansion portion of the system configured to allow the beam to expand after exiting the second octupole magnet before striking the target.

8. The system of claim 7, further comprising:
one or more power units coupled to magnets within the first and second assemblies of quadrupole magnets and the first and second octupole magnets, and configured to control power applied to at least some of the magnets in response to control signals;
a beam quality sensor positioned near the target and configured to provide information regarding at least one of a uniformity, shape, size, or position of the beam near the target; and
a computing system electronically coupled the one or more power units and the sensor positioned near the target, wherein the computing system executes processor-executable instructions that cause the computing system to:
receive information from the sensor regarding at least one of a uniformity, shape, size, or position of the beam near the target;
determine based on the information received from the sensor regarding at least one of a uniformity, shape, size, or position of the beam near the target changes to magnetic field strengths of magnets in one or more of the first and second assemblies of quadrupole magnets and first and second octupole magnets to maintain the beam striking the target; and
output control signals to the one or more power units based on the determined changes to magnetic field strengths.

9. The system of claim 8, wherein the beam quality sensor is a beam-induced fluorescence monitor.

10. The system of claim 7, further comprising a third assembly of quadrupole magnets positioned within the beam expansion portion, wherein magnetic strengths of magnets within the third assembly of quadrupole magnets are adjusted to control a degree of expansion of the beam before striking the target.

11. The system of claim 7, further comprising an achromat bend including a plurality of quadrupole magnets configured to focus the beam and compensate for chromatic dispersion in the beam received from the accelerator.

12. The system of claim 7, further comprising a target station comprising a mechanism for holding and loading targets into a target positioning device configured to hold a target in the path of the beam of charged particles.

13. A method performed by a computing system for controlling a charged particle beam within a charged particle beam management and control system, the method comprising:
controlling by the computing system one or more power units that power various magnets within the charged particle beam management and control system;
receiving in the computing system beam quality information from a beam sensor at or near a target regarding at least one of beam size, shape, or position;
determining by the computing system adjustments to magnetic field strengths or power applied to one or more system magnets to maintain beam quality based on the received beam quality information; and
controlling by the computing system the one or more power units based on determined adjustments to magnetic field strengths or power applied to one or more system magnets.

14. The method of claim 13, wherein the computing system determines adjustments to magnetic field strengths or power applied to one or more system magnets to maintain beam quality based on the received beam quality information using an optimization algorithm.
